(19) United States
(12) Patent Application Publication
(10) Pub. No.: US 2017/0223753 A1
(43) Pub. Date: Aug. 3, 2017

(54) A COMMUNICATION DEVICE, A RELAY DEVICE, A NETWORK NODE AND METHODS THEREIN FOR ENABLING A RELAY IN A RADIO COMMUNICATIONS NETWORK

(71) Applicant: TELEFONAKTIEBOLAGET LM ERICSSON (PUBL), Stockholm (SE)

(72) Inventors: Andreas HÖGLUND, SOLNA (SE); Yufei BLANKENSHIP, KILDEER, IL (US)

(73) Assignee: TELEFONAKTIEBOLAGET LM ERICSSON (PUBL), Stockholm (SE)

(21) Appl. No.: 15/514,854

(22) PCT Filed: Oct. 3, 2014
(86) PCT No.: PCT/SE2014/051145

§ 371 Date: Mar. 28, 2017

(51) Int. Cl. H04W 76/02; H04W 72/04

(52) U.S. Cl. CPC H04W 76/02; H04W 72/048; H04W 88/04

(57) ABSTRACT

Embodiments herein relate to a communication device and method therein for enabling a relay in a radio communications network. First, the communication device transmits a request for a relay device to serve as a relay for communication device. Then, the communication device receives an acknowledgement message from a relay device indicating that the relay device is to serve as a relay between the communication device and a network node (110) in the radio communications network. Embodiments herein further relate to a relay device, a network node and methods therein for enabling a relay in a radio communications network.

### TECHNICAL FIELD

Embodiments herein relate to relaying in a radio communications network. In particular, embodiments herein relate to a communication device and a method therein for enabling a relay in a radio communications network. Further, embodiments herein also relate to a relay device, a network node and methods therein for enabling a relay in a radio communications network.

### BACKGROUND

In a typical radio communications network, communication devices, also known as wireless devices, mobile stations, terminals, and/or User Equipments, UEs, communicate via a Radio Access Network, RAN, with one or more core networks. The RAN covers a geographical area which is divided into cell areas, with each cell area being served by a base station, e.g. a radio base station, RBS, or network node, which in some networks may also be called, for example, a “NodeB”, “eNodeB” or “eNB”. A cell is a geographical area where radio coverage is provided by the radio base station at a base station site or an antenna site in case the antenna and the radio base station are not collocated. Each cell is identified by an identity within the local radio area, which is broadcast in the cell. Another identity identifying the cell uniquely in the whole mobile network is also broadcasted in the cell. One radio base station may have one or more cells. The base stations communicate over the air interface operating on radio frequencies with the wireless devices within range of the base stations.

A Universal Mobile Telecommunications System, UMTS, is a third generation mobile communication system, which evolved from the second generation, 2G, Global System for Mobile Communications, GSM. The UMTS terrestrial radio access network, UTRAN, is essentially a RAN using wideband code division multiple access, WCDMA, and/or High Speed Packet Access, HSPA, for user equipments. In a forum known as the Third Generation Partnership Project, 3GPP, telecommunications suppliers propose and agree upon standards for third generation networks and UTRAN specifically, and investigate enhanced data rate and radio capacity. In some versions of the RAN as e.g. in UMTS, several base stations may be connected, e.g., by landlines or microwave, to a controller node, such as a radio network controller, RNC, or a base station controller, BSC, which supervises and coordinates various activities of the plural base stations connected thereto. The RNCs are typically connected to one or more core networks.

Specifications for the Evolved Packet System, EPS, have been completed within the 3^{rd} Generation Partnership Project, 3GPP, and this work continues in the coming 3GPP releases. The EPS comprises the Evolved Universal Terrestrial Radio Access Network, E-UTRAN, also known as the Long Term Evolution, LTE, radio access, and the Evolved Packet Core, EPC, also known as System Architecture Evolution, SAE, core network. E-UTRAN/LTE is a variant of a 3GPP radio access technology wherein the radio base station nodes are directly connected to the EPC core network rather than to RNCs. In general, in E-UTRAN/LTE the functions of a RNC are distributed between the radio base stations nodes, e.g. eNodeBs in LTE, and the core network. As such, the Radio Access Network, RAN, of an EPS has an essentially “flat” architecture comprising radio base station nodes without reporting to RNCs.

In a radio communications network as described above, a key performance indicator for some communication devices, such as, for example, Machine-Type-Communication, MTC, devices, is radio coverage. This is because these MTC devices are often located in areas with poor radio coverage, such as, for example, in basements. Furthermore, since these MTC devices often are stationary, the MTC device cannot rely on time diversity to improve its radio coverage.

In Release 12 of the 3GPP RAN1 standard documentation, an energy boosting and time repetition procedure has been suggested in order to improve the radio coverage of these communication devices, e.g. MTC devices. However, because the energy at the receiver side, i.e. at the MTC device, depends on the distance as in Eq. 1:

$${P}_{rx} ∝ {P}_{tx} \frac{1}{{( 4 π r )}^{α}} \qquad ( Eq . 1 )$$

wherein Pᵣₓ is the energy at the receiver side, Pₜₓ is the energy at the transmitter side, and r is the distance between the receiver and the transmitter.

The energy boosting and time repetition procedure and similar methods are only feasible up to a certain distance from the radio base station, i.e. network node. For larger distances, a large and unpractical number of repetitions will be required to accumulate the energy to produce a sufficient Signal-to-Noise Ratio, SNR, needed to decode the signal.

This leaves the operator with the choice to densify the radio communications network by either deploying additional radio base stations or use relay stations. However, since there are large costs that are related to deploying new radio base stations, the use of relay stations seems to be a more likely solution in order to provide an improved radio coverage for some communication devices, such as, e.g. MTC devices.

Relay stations have been standardized for E-UTRAN in 3GPP already in Release 10. According to this standard, the relay stations are meant to be stationary deployed by the operator of the radio communication network permanently at fixed geographical locations. These relay stations forwards all transmissions that is sent out by the radio base station, i.e. transmits all pilot signals, broadcast signals, etc., that is sent out by the radio base station, and thus in large functions like a micro radio base station with a wireless backhaul.

However, there are several issues associated with using relay stations according to the 3GPP E-UTRAN Release 10 standard for relaying data transmission for some communication devices, such as, e.g. for MTC devices. Firstly, planned operator deployment of permanently placed relay stations are not an economically feasible alternative when improving the radio coverage, thus also the power consumption, of only a few or small number of MTC devices. Moreover, to provide improved radio coverage for uniformly distributed MTC devices, a large number of relay stations would be needed. For example, in a worst case scenario, it may be so that one relay station is needed per MTC device which is in need of improving its radio coverage. Each of these relay stations would also transmit pilot signals, synchronisation signals and System Information, SI, signals, etc., continuously, and therefore contribute to pilot signal contamination in the radio communications network.

### SUMMARY

It is an object of embodiments herein to improve relaying for communication devices.

According to a first aspect of embodiments herein, the object is achieved by a method performed by a communication device for enabling a relay in a radio communications network. The method comprises transmitting a request for a relay device to serve as a relay for the communication device. Also, the method comprises receiving an acknowledgement message from a relay device indicating that the relay device is to serve as a relay between the communication device and a network node in the radio communications network.

According to a second aspect of embodiments herein, the object is achieved by a communication device for enabling a relay of a data transmission in a radio communications network. The communication device comprises a transmitter configured to transmit a request for a relay device to serve as a relay for the communication device. Also, the communication device comprises a receiver configured to receive an acknowledgement message from a relay device indicating that the relay device is to serve as a relay between the communication device and a network node in the radio communications network.

According to a third aspect of embodiments herein, the object is achieved by a method performed by a relay device for enabling a relay in a radio communications network. The method comprises receiving, from a communication device, a request to serve as a relay for the communication device. Also, the method comprises transmitting, to a network node in the radio communications network, a control message indicating that the relay device is able to serve as a relay between the communication device and the network node. Furthermore, the method comprises receiving, from the network node, a first acknowledgement message configuring the relay device to serve as a relay between the communication device and the network node. Also, the method comprises transmitting, to the communication device, a second acknowledgement message indicating that the relay device is to serve as a relay between the communication device and the network node.

According to a fourth aspect of embodiments herein, the object is achieved by a relay device for enabling a relay in a radio communications network. The relay device comprises a receiver configured to receive, from a communication device, a request to serve as a relay for the communication device. Also, the relay device comprises a transmitter configured to transmit a control message to a network node in the radio communications network indicating that the relay device is able to serve as a relay between the communication device and the network node. Furthermore, the receiver is further configured to receive, from the network node, a first acknowledgement message configuring the relay device to serve as a relay between the communication device and the network node. Also, the transmitter is configured to transmit, to the communication device, a second acknowledgement message indicating that the relay device is to serve as a relay between the communication device and the network node.

According to a fifth aspect of embodiments herein, the object is achieved by a method performed by a network node for enabling a relay in a radio communications network. The method comprises receiving a control message from a first relay device indicating that the first relay device is able to serve as a relay between a communication device and the network node. Also, the method comprises transmitting an acknowledgement message to the first relay device configuring the first relay device is to serve as a relay between the communication device and the network node.

According to a sixth aspect of embodiments herein, the object is achieved by a network node for enabling a relay in a radio communications network. The network node comprises a receiver configured to receive a control message from a first relay device indicating that the first relay device is able to serve as a relay between a communication device and the network node. Also, the network node comprises a transmitter configured to transmit an acknowledgement message to the first relay device configuring the first relay device is to serve as a relay between the communication device and the network node.

According to a seventh aspect of embodiments herein, the object is achieved by a computer program, comprising instructions which, when executed on at least one processor, cause the at least one processor to carry out the methods described above. According to an eight aspect of embodiments herein, the object is achieved by a carrier containing the computer program described above, wherein the carrier is one of an electronic signal, optical signal, radio signal, or computer readable storage medium.

By having the communication device transmitting a request for a relay device, one or more relay devices in the vicinity of the communication device listening for requests of communication devices may transmit a control message to its serving network node indicating that it may serve as a relay for the communication device. This means that the network node receiving the incoming control messages from the one or more relay devices, each indicating that each of them may serve as a relay for a communication device, the network node is able to determine the most suitable relay device in the radio communications network for performing relaying between the network node and the communication device.

This provides an ad-hoc setup of relay devices with on-demand relaying, which means that there is no need for a planned deployment of relay devices and no active relay devices unless needed. Thus, advantages such as economically feasible coverage improvements, power consumption gains and, in the case of data accumulation in the relay, offloading of the network node are provided. It further improves the signalling in the radio communications network by not contributing to pilot signal contamination.

Hence, relaying for communication devices is improved.

### BRIEF DESCRIPTION OF THE DRAWINGS

Embodiments will now be described in more detail in relation to the enclosed drawings.

FIG. 1 is a schematic block diagram illustrating embodiments of a communication device and embodiments of a relay device and a network node in a radio communications network,

FIG. 2 is a signalling diagram depicting embodiments of a communication device, a relay device and a network node,

FIG. 3 is a flowchart depicting embodiments of a method in a communication device,

FIG. 4 is a flowchart depicting embodiments of a method in a relay device,

FIG. 5 is a flowchart depicting embodiments of a method in a network node,

FIG. 6 is a schematic block diagram depicting embodiments of a communication device,

FIG. 7 is a schematic block diagram depicting embodiments of a relay device,

FIG. 8 is a schematic block diagram depicting embodiments of a network node.

### DETAILED DESCRIPTION

The figures are schematic and simplified for clarity, and they merely show details for the understanding of the embodiments presented herein, while other details have been left out.

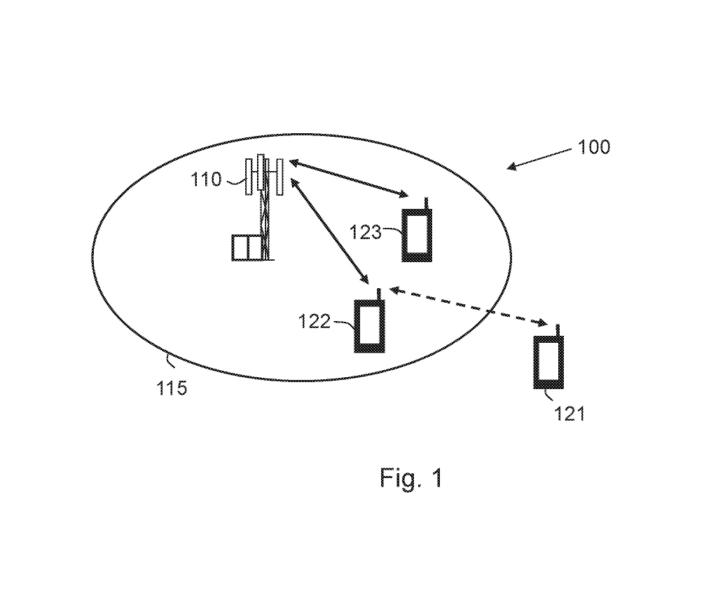

FIG. 1 shows an example of a radio communications network 100 in which embodiments herein may be implemented. In this example, the radio communications network 100 may be any wireless communication system, such as, for example, Long Term Evolution (LTE) or other 3GPP cellular network or system. The radio communications network 100 comprises a network node 110.

The network node 110 may e.g. be an eNB, eNodeB, or a Home Node B, a Home eNode B, femto Base Station (BS), pico BS or any other network unit capable of serving a communication device in the radio communications network 100. The network node 110 may also be e.g. a radio base station, a base station controller, a network controller, a relay node, a repeater, an access point, a radio access point, a Remote Radio Unit (RRU) or a Remote Radio Head (RRH). Furthermore, the network node 110 comprises one or more antennas for wireless radio communication with communication devices located within their range; that is, the network node 110 may use one or more of its antennas to provide radio coverage within its cell 115. The network node 110 communicates over the air or radio interface operating on radio frequencies with the communication devices within the cell 115 of the network node 110.

A communication device 121 is located outside of the cell 115 and at least one relay device 122, 123 are located within the cell 115. While a relay station and a relay device 122, 123 both serve the function of relaying data between a communication device 121 and a network node 110, a relay device 122, 123 is different from a relay station in nature. A relay station is a network node or base station in nature. A relay station appears as a base station to a communication device being served, and it appears as a peer base station to a base station/network node it connects to. In contrast, the relay device 122, 123 appears as a peer device to the communication device 121 it is connected to, while also appearing as a terminal/communication device to the base station/network node 110 it is connected to.

The communication device 121 and the at least one relay device 122, 123 are both configured to communicate within the radio communications network 100 via the network node 110 over a radio link when present in the cell 115 served by the network node 110. The at least one relay device 122, 123 may e.g. be any kind of wireless device, such as, a mobile phone, a cellular phone, a Personal Digital Assistant (FDA), a smart phone, a tablet, a sensor equipped with a wireless device, Laptop-Mounted Equipment (LME) (e.g. USB), Laptop-Embedded Equipment (LEE), Machine-Type-Communication (MTC) device, a wireless device with D2D capability, Customer Premises Equipment (CPE), etc.

The communication device 121 may also be any kind of wireless device as described above for the relay devices 122, 123, however, it should be noted that the embodiments described herein are particularly advantageous when the communication device 121 is e.g. an MTC device. This is because given the coverage improvement requirement for MTC devices, enabling relaying for these MTC device is an important issue since this may provide large coverage enhancements for these MTC device which would otherwise be consuming large amounts of power and radio resources, e.g. by using time repetition. The embodiment described herein further makes relaying practically feasible for battery operated devices using extended-Discontinuous Reception, DRX, or Power Saving Mode, PSM. For example, in some embodiments, the sleeping cycles of the communication device 121 and the relay devices 122, 123, such as, e.g. DRX or PSM TAU periods, may advantageously be aligned with the transmissions of requests according to the embodiments herein.

As described in the background part above, there are several issues associated with using relay stations according to the 3GPP E-UTRAN Release 10 standard for relaying data transmission for communication devices in order to improve radio coverage, particularly for communication devices such as MTC devices.

In accordance with embodiments described herein, these issues are addressed by having the communication device transmitting a request for a relay device, and one or more relay devices in the vicinity of the communication device listening for requests of communication devices. Then, the one or more relay devices may transmit a control message to its serving network node indicating that it may serve as a relay for the communication device. This means that the network node receiving the incoming control messages from the one or more relay devices, which each indicate that the relay device may serve as a relay for the communication device, is able to determine the most suitable relay device in the radio communications network for performing the relaying between the network node and the communication device.

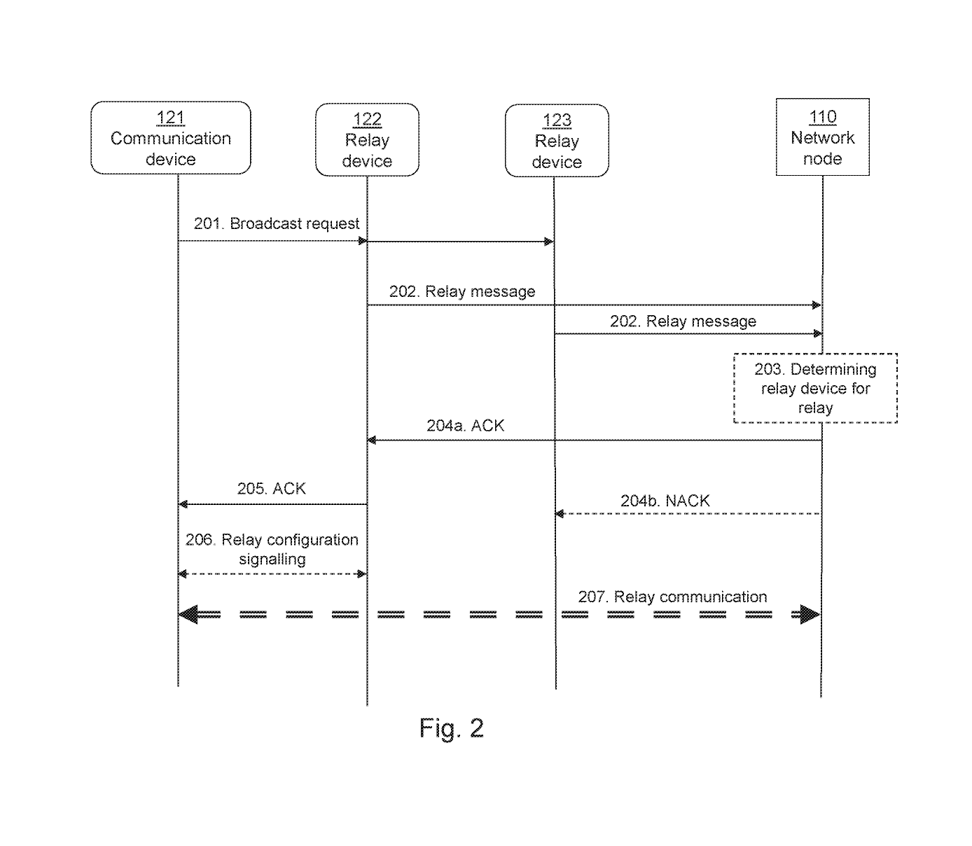

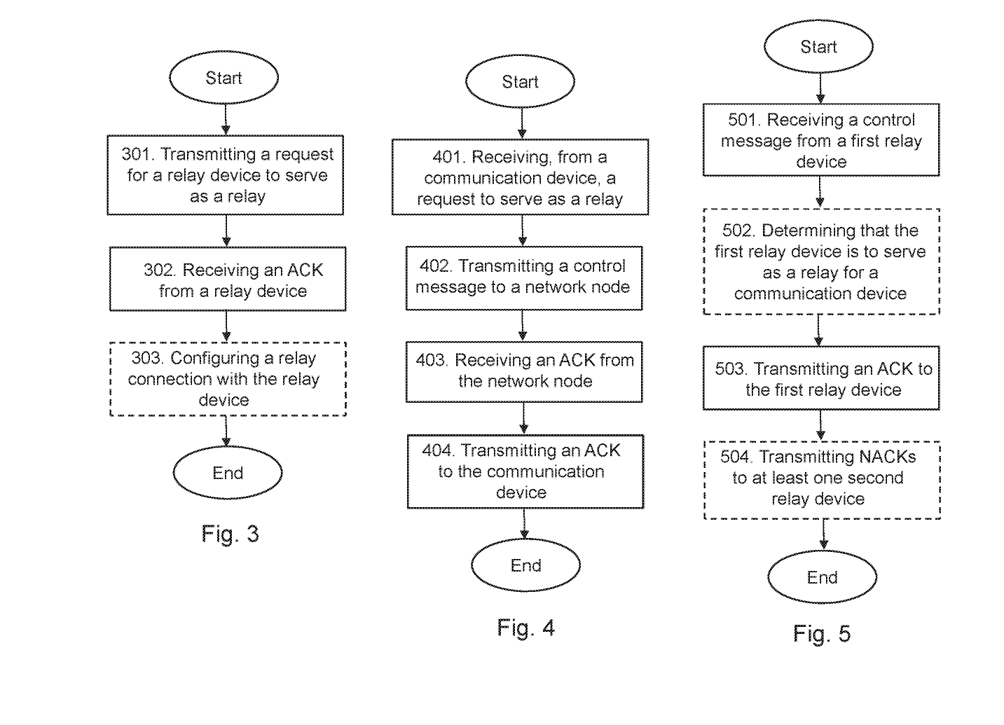

An overview of embodiments of methods performed by the communication device 121, the relay devices 122, 123, and the network node 110, will now be described with reference to the schematic signalling diagram depicted in FIG. 2. FIG. 2 is an illustrated example of actions or operations which may be taken by the involved nodes and devices. A more detail description of the embodiments of methods performed by the communication device 121, the relay devices 122, 123, and the network node 110, is provided with reference to the flow charts in FIGS. 3-5, respectively.

Action 201

The communication device 121 may transmit a request for a relay device 122, 123 to serve as a relay for the communication device 121. Thus, for example, the relay devices 122, 123 may receive, from the communication device 121, a request to serve as a relay for the communication device 121.

Action 202

After receiving the request, one or more of the relay devices 122, 123 transmits, to the network node 110, a control message indicating that the relay device 122, 123, respectively, is able to serve as a relay between the communication device 121 and the network node 110. Thus, the network node 110 may receive at least one control message from at least one relay device 122, 123 indicating that the at least one relay device 122, 123 is able to serve as a relay between the communication device 121 and the network node 110.

Action 203

In this optional action, in case there is more than one relay device 122, 123 from which the network node 110 has received control messages, the network node 110 may determine that a first relay device, e.g. the relay device 122, is to serve as a relay between the communication device 121 and the network node 110.

Action 204a

In this action, the network node 110 transmits an acknowledgement message, ACK, to the first relay device, e.g. the relay device 122. The ACK may configure the first relay device, e.g. relay device 122, to serve as a relay between the communication device 121 and the network node 110. Thus, in this example, the relay device 122 may receive, from the network node 110, the ACK configuring the first relay device, e.g. relay device 122, to serve as a relay between the communication device 121 and the network node 110.

Action 204b

Optionally, in case there are more than one relay device 122, 123 from which the network node 110 has received control messages, the network node 110 may here also transmit a negative acknowledgement message, NACK, to at least one second relay device, e.g. the relay device 123, which it has determined is not to serve as a relay between the communication device 121 and the network node 110.

Action 205

After receiving an ACK from the network node 110, the relay device 122 will in turn transmit, to the communication device 121, an ACK indicating that the relay device 122 is to serve as a relay between the communication device 121 and the network node 110. Thus, the communication device 121 will receive the ACK from the relay device 122 indicating that the relay device 122 is to serve as a relay between the communication device 121 and a network node 110.

Action 206

After receiving the ACK from the relay device 122, the communication device 121 may configure a relay connection with the relay device 122. When the relay connection is configured or set up, the relay device 122 may relay data communication, i.e. one or more data transmissions, between the communication device 121 and the network node 110.

This means that for downlink data transmissions, the relay device 122 may receive data transmissions on behalf of the communication device 121 from the network node 110, and then transmit the received data to the communication device 121 over the configured relay connection. Correspondingly, for uplink data transmissions, the relay device 122 may receive data transmissions from the communication device 121 via the configured relay connection, and then transmit the received data to the network node 110 via its cellular uplink, UL, channel towards the network node 110.

Example of embodiments of a method performed by a communication device 121 for enabling a relay in a radio communications network 100, will now be described with reference to the flowchart depicted in FIG. 3. FIG. 3 illustrates an example of actions or operations which may be taken by the communication device 121.

Action 301

First, the communication device 121 transmits a request for a relay device 122, 123 to serve as a relay for the communication device 121. This means that the communication device 121, when in need of relaying, may send out a message requesting a relay device to function as a relay between the communication device 121 and the network node 110. In some embodiments, the request may be broadcasted by the communication device 121.

In some embodiments, the transmission of the request may further comprise determining that at least one property of the communication device 121 fulfils at least one condition. This means that the need for relaying may be determined by the communication device 121, e.g. based on a combination of factors and conditions. In some embodiments, the at least one condition may relate to one or more of:
a signal strength or a channel quality towards the network node 110 in the radio communications network 100. For example, in case the communication device 121 is experiencing poor channel quality to the strongest network node or macro base station, e.g. the network node 110 in the radio communications network 100.
a mobility information of the communication device 121. For example, the communication device 121 may be suitable to connect via a relay device 122, 123 if the communication device 121 is stationary or slow-moving relative to the relay device 122, 123. On the other hand, if the communication device 121 is fast moving relative to the relay device 122, 123, then the communication device 121 should not establish a relay link via the relay device 122, 123.
a power consumption requirement of the communication device 121. For example, in case the communication device 121 comprises strict power consumption requirements. One example of this is that the communication device 121 may be expected to have low power consumption, e.g., operating for up to ten years on a pair of AA battery without battery change.
a subscription information of the communication device 121. For example, the subscription information stored in a Home Subscriber Server, HSS, about the communication device 121 may indicate that this communication device 121 is massively deployed machine type devices, i.e. MTC-devices, with low mobility and low power consumption requirements. Some examples of such devices may be water meters or power meters deployed, e.g. in basements of apartment buildings by a utility companies.
a Quality-of-Service requirement of the communication device 121. For example, the QoS of the consumer devices, such as, e.g. the communication device 121, may indicate that it has low date rate and is able to tolerate long delay.
an identity of the communication device 121. This may be used, for example, in case the communication device 121 is a machine-type device deployed by utility company A and has been assigned specially defined device identities, different from identities of normal consumer devices, such as, e.g. mobile terminals or smart phones.
a group assignment of the communication device 121. This may be used, for example, when a group assignment is used to differentiate consumer devices in different locations, such as, e.g. consumer devices deployed in a basement and consumer devices deployed in upper floors. Another option is when a group assignment is used to differentiate consumer devices deployed by different owners, such as, e.g. consumer devices deployed by utility companies and devices deployed by individual users. A further option is group assignment to differentiate consumer devices of different services, such as, e.g. consumer devices for security surveillance and consumer devices for monthly electricity consumption report.
an operator serving the communication device 121. For example, when having an operator A whose network is upgraded to support relay device for machine type devices, and an operator B whose network is not upgraded to support machine type devices.
a battery operated indicator of the communication device 121. For example, in case the communication device 121 is battery operated and needs to conserve transmission power. This, for example, in contrast to communication devices which are plugged in to wall outlet and do not have stringent power consumption requirements.

Furthermore, transmission of the request may be a Device-to-Device, D2D, communication initiated by the communication device 121. This may, for example, be performed by the communication device 121 being in a transmitting mode and transmitting D2D synchronization signals, D2DSS, in order to make the communication device 121 discoverable by the relay devices 122, 123 being in a receiving mode and capable of receiving the D2D synchronization signals, D2DSS, from the communication device 121. Alternatively, transmission of the request may be a Device-to-Device, D2D, communication initiated by the relay devices 122, 123. This may, for example, be performed by the relay devices 122, 123 periodically transmitting D2D discovery beacons in order to discover the communication device 121 in need of relaying. In this case, the communication device 121 has to be able to receive the discovery beacons from the relay devices 122, 123 during the periodical transmissions.

It should be noted that, in some embodiments, the transmission of the request may be performed at a determined time in the radio communications network 100. This may refer to a determined time when the relay devices 122, 123 in the radio communications network 100 are configured to listen for requests from the communication device 110, which may be broadcasted. This determined time may also be referred to as a time slot and/or time instant. Advantages of using a determined time comprise minimizing the control signaling/broadcast overhead and maximizing battery life time of the communication device 121 and the relay device 122, 123.

In case of having a determined time in the radio communications network 100 for transmitting the request, the communication device 121 may, e.g. when being in an area with bad coverage in the radio communication network 100, have difficulties to synchronize with the determined time used in the radio communication network 100. This is because, for example, if the determined time is defined as one or several radio communication network frames, the communication device 121 would need to be able to read the Single Frequency Network, SFN, broadcast from at least one cell of the network node 110. Existing coverage enhancement solutions using time repetitions have been found which may increase the coverage of the radio communication network broadcasts by up to 15 dB. If such a solution is implemented in the radio communications network 100, this solution could be reused for the communication device 121 to obtain synchronization, and possibly SFN broadcast. However, the communication device 121 may advantageously be configured to select relaying, according to the embodiments herein, after the synchronization is achieved, instead of continuing to use a time repetition operation.

According to another example, the determined time may be a determined time window on a long time scale, such as, e.g. one minute every full hour. According to a further example, the determined time may be a Discontinuous Transmission, DTX, of a certain cycle length. In these cases, the communication device 121 in need of relaying would only need a fairly accurate internal clock signal, and would not need to rely on any synchronization or signals from the network node 110.

It should also be noted that in some embodiments, the request may be configured in the same manner as, or similar to, a so-called Sounding Reference Signal, SRS. However, this would require it to be different in at least one aspect such that they are each uniquely distinguishable.

Action 302

In this action, the communication device 121 receives an acknowledgement message, ACK, from a relay device 122, 123 indicating that the relay device 122, 123 is to serve as a relay between the communication device 121 and a network node 110 in the radio communications network 100. Hence, the communication device 121 may thus be made aware of which relay device 122, 123 that has been determined by the network node 110 to perform the relay operation for the communication device 121 and thus which relay device 122, 123 it is to use when relaying one or more data transmissions for the communication device 121.

Action 303

Optionally, in this action, the communication device 121 may configure a relay connection with the relay device 122, 123. This may be performed after having received the ACK in Action 302. The configuration of the relay connection may comprise setting up a D2D link between the communication device 121 and the relay device 122, 123. It should also be noted that during the time the relay connection, e.g. a D2D link, is active, the communication device 121 does not need to perform any random access channel, RACH, procedure towards the network node 110. However, in case the relay connection is lost, the communication device 121 may fall back to using a RACH procedure towards the network node 110.

Example of embodiments of a method performed by a relay device 122, 123 for enabling a relay in a radio communications network 100, will now be described with reference to the flowchart depicted in FIG. 4. FIG. 4 illustrates an example of actions or operations which may be taken by the relay device 122, 123.

Action 401

Initially, the relay device 122, 123 receives, from a communication device 121, a request to serve as a relay for the communication device 121. It should here be noted that the relay device 122, 123 also may receive requests to serve as a relay from more than one communication device.

When the request is received at the relay device(s) 122, 123, the relay device(s) 122, 123 may determine if the request from the communication device 121 should be acknowledged. For example, in order to make proper decision to acknowledge or reject the request from the communication device 121, the relay device 122, 123 may perform link quality measurement of both link “A”, i.e. the radio link between the communication device 121 and the relay device 122, 123, and link “B”, i.e. the radio link between the relay device 122, 123 and the network node 110. The relay device 122, 123 may decide to acknowledge the request if both link “A” and link “B” have a link quality that is above a certain threshold level. The relay device 122, 123 may also decide to reject, or not respond to, the request from communication device 121 if one, or both, of link “A” and link “B” does not have sufficiently good link quality, i.e. above a threshold level. The link quality of link “A” may be measured using the uplink, UL, signal from the communication device 121, while the link quality of link “B” may be measured using the downlink, DL, signal from the network node 110.

In addition to link quality, other factors may also be taken into account by the relay devices 122, 123. For example, the load is another factor, where the load may be the number of communication devices being served by the relay devices 122, 123, and/or the amount of UL/DL traffic that the relay devices 122, 123 are already handling.

While the decision to acknowledge or reject may be made by each relay device 122, 123, the decision may also be made by the network node 110. The network node may also be configured to take into account the link quality, traffic load, number of relay devices 122, 123 and communication devices 121 in the cell 115, and the distribution of relay devices 122, 123 and communication devices 121 in the cell 115.

Alternatively, it is conceivable according to some embodiments that a decision may also be made by the communication device 121. In this case, the relay devices 122, 123 may, for example, inform the communication device 121 about how well they could serve as a relay, such as, for example, notifying the communication device 121 about the quality of links “A” an “B”. Then, in this case, the communication device 121 may itself determine which of the relay devices 122, 123 to use as a relay. This relay determination may then be based on similar considerations as described for the network node 110 in the following.

Action 402

In this action, the relay device 122, 123 transmits, to a network node 110 in the radio communications network 100, a control message indicating that the relay device 122, 123 is able to serve as a relay between the communication device 121 and the network node 110. This advantageously allows the network node 110 to be made aware of the capability of the relay device 122, 123 to perform a relay operation between the network node 110 and the communication device 121.

In some embodiments, the relay device 122, 123 may perform the transmitting when at least one property of the communication device 121 fulfils at least one condition. In some embodiments, the at least one condition may relate to one or more of:
a signal strength and/or a channel quality between the communication device 121 and the relay device 122, 123. For example, the relay device 122, 123 may perform the transmission when the signal strength and/or channel quality of the received request is above a determined threshold.
a mobility information of the communication device 121. Here, similar considerations may be taken by the relay device 122, 123 as described above for the communication device 121 in view of the mobility information of the communication device 121.
a subscription information of the communication device 121. Here, similar considerations may be taken by the relay device 122, 123 as described above for the communication device 121 in view of the subscription information of the communication device 121.
a Quality-of-Service, QoS, requirement of the communication device 121. Here, similar considerations may be taken by the relay device 122, 123 as described above for the communication device 121 in view of the Quality-of-Service, QoS, requirement of the communication device 121.
an identity of the communication device 121. Here, similar considerations may be taken by the relay device 122, 123 as described above for the communication device 121 in view of the identity of the communication device 121.
a group assignment of the communication device 121. Here, similar considerations may be taken by the relay device 122, 123 as described above for the communication device 121 in view of the group assignment of the communication device 121.
an operator serving the communication device 121. Here, similar considerations may be taken by the relay device 122, 123 as described above for the communication device 121 in view of the operator of the communication device 121.

In some embodiments, the relay device 122, 123 may perform the transmitting when at least one condition is fulfilled by the relay device 122, 123. In some embodiments, the at least one condition relates to one or more of:
a signal strength or a channel quality between the relay device 122, 123 and the network node 110. For example, in case the relay device 122, 123 is experiencing a signal strength or channel quality to the network node 110 that is below a determined threshold level.
a mobility information of the relay device 122, 123. For example, the relay device 122, 123 may be suitable to serve as a relay if the relay device 122, 123 is somewhat stationary or slow-moving relative to the network node 110.
a power consumption requirements of the relay device 122, 123. For example, in case the relay device 122, 123 comprise strict power consumption requirements.
a subscription information of the relay device 122, 123. For example, the relay device 122, 123 may be suitable to serve as a relay for the communication device 121 with its current subscription.
a Quality-of-Service requirement of the relay device 122, 123. For example, the relay device 122, 123 may be suitable to serve as a relay for the communication device 121 with its current Quality-of-Service requirement.
an identity of the relay device 122, 123. For example, a current identity of the relay device 122, 123 may indicate that it is not suitable to serve as a relay for the communication device 121.
a group assignment of the relay device 122, 123. For example, a current group assignment of the relay device 122, 123 may indicate that it is not suitable to serve as a relay for the communication device 121.
an operator serving the relay device 122, 123. For example, a current operator of the relay device 122, 123 may allow the relay device 122, 123 to serve as a relay for the communication device 121, optionally this may be dependent upon whether the communication device 121 and the relay device 122, 123 has the same operator or not.
a battery operated indicator in the relay device 122, 123. For example, a current energy level of the battery of the relay device 122, 123 may indicate that it is not suitable to serve as a relay for the communication device 121.

In some embodiments, when the relay device 122, 123 receives more than one request from more than one communication device 121, the relay device 122, 123 may transmit a control message for only an n:th number of communication devices in need of relaying, wherein n may be any number. This may be advantageous in case the relay devices 122, 123 only comprise a limited capability to operate as a relay, i.e. for a limited amount of communication devices.

Action 403

Here, the relay device 122, 123 receives, from the network node 110, a first acknowledgement message, ACK, configuring the relay device 122 to serve as a relay between the communication device 121 and the network node 110. Hence, the relay device 122, 123 is thus made aware of that has it has been determined by the network node 110 to perform the relay operation towards the communication device 121.

Action 404

Then, the relay device 122, 123 transmits, to the communication device 121, a second acknowledgement message, ACK, indicating that the relay device 122, 123 is to serve as a relay between the communication device 121 and the network node 110. This means that the determined relay device of the network node 110 is further communicated to the communication device 121 by the determined relay device 122, 123 and that connections or associations between the communication device 121 and the relay device 122, 123 for the relay operation may be configured.

Example of embodiments of a method performed by a network node 110 for enabling a relay in a radio communications network 100, will now be described with reference to the flowchart depicted in FIG. 5. FIG. 5 illustrates an example of actions or operations which may be taken by the network node 110.

Action 501

First, the network node 110 receives a control message from a first relay device 122 indicating that the first relay device 122 is able to serve as a relay between a communication device 121 and the network node 110. It should here be noted that the network node 110 also may receive control messages from more than one relay device 122, 123 to serve as a relay for the communication device 121. This may, for example, occur when the request from the communication device 121 has been received by more than one relay device 122, 123 served by the network node 110 in the radio communications network 100.

Action 502

Optionally, the network node 110 may then determine that the first relay device 122 is to serve as a relay between the communication device 121 and the network node 110 based on at least one property of the first relay device 122 and/or at least one property of a link between the first relay device 122 and the network node 110. This means that the network node 110 may determine which of the at least one relay device 122, 123, i.e. relay-candidate devices, that is most suited to serve as a relay and determine that this relay device 122, 123 is to serve as the relay for the communication device 121. This may, for example, occur when the network node 110 receives control messages from more than one relay device 122, 123. In some embodiments, the at least one property of the first relay device 122 and/or at least one property of a link between the first relay device 122 and the network node 110 relates to one or more of:
a signal strength or a channel quality towards the communication device 121. For example, the network node 110 may determine that the relay device 122, 123 which provide the highest end-to-end signal strength or channel quality towards the communication device 121 is to perform the relay operation towards the communication device 121.
a signal strength or a channel quality towards the first relay device 122. For example, the network node 110 may determine that the relay device 122, 123 which provide the highest strength or channel quality towards the network node 110 is to perform the relay operation towards the communication device 121.
a mobility information of the first relay device 122. Here, similar considerations may be taken by the network node 110 as described above for the relay device 122, 123 in view of the mobility information of the relay device 122, 123.
a mobility information of the communication device 121. Here, similar considerations may be taken by the network node 110 as described above for the communication device 121 and/or the relay device 122, 123 in view of the mobility information of the communication device 121. Furthermore, in this case, the network node 110 may, for example, have access to stored statistics in order to predict which relay device 122, 123 that would be the most suitable relay for the communication devices 121 over time, in contrast to being most suitable for the moment.
a power consumption requirement of the first relay device 122. For example, the network node 110 may determine that the relay device 122, 123 whose power consumption requirements allows it to most suitably function as a relay device, e.g. for the longest period of time, towards the communication device 121.
a Quality-of-Service, QoS, requirement of the first relay device 122. Here, similar considerations may be taken by the network node 110 as described above for the relay device 122, 123 in view of the Quality-of-Service, QoS, requirements of the relay device 122, 123.
a Quality-of-Service, QoS, requirement of the communication device 121. Here, similar considerations may be taken by the network node 110 as described above for the relay device 122, 123 in view of the Quality-of-Service, QoS, requirements of the communication device 121.
an identity of the first relay device 122. Here, similar considerations may be taken by the network node 110 as described above for the relay device 122, 123 in view of the identity of the relay device 122, 123.
an identity of the communication device 121. Here, similar considerations may be taken by the network node 110 as described above for the communication device 121 and/or the relay device 122, 123 in view of the identity of the communication device 121.
a group assignment of the first relay device 122. Here, similar considerations may be taken by the network node 110 as described above for the relay device 122, 123 in view of the group assignment of the relay device 122, 123.
a group assignment of the communication device 121. Here, similar considerations may be taken by the network node 110 as described above for the communication device 121 and/or the relay device 122, 123 in view of the group assignment of the communication device 121.
an operator serving the first relay device 122 and/or the communication device 121. Here, similar considerations may be taken by the network node 110 as described above for the communication device 121 and/or the relay device 122, 123 in view of the operator(s) serving the relay device 122, 123 and the communication device 121.
a battery operated indicator of the first relay device 122 and/or the communication device 121. For example, the network node 110 may determine that a relay device of the relay devices 122, 123 which indicate that it needs to conserve transmission power due to e.g. low battery charge should not perform the relay operation towards the communication device 121.

Action 503

In this action, the network node 110 transmits an acknowledgement message, ACK, to the first relay device 122 configuring the first relay device 122 is to serve as a relay between the communication device 121 and the network node 110. This means that the network node 110 may notify the first relay device 122 that it has been determined by the network node 110 to perform the relay operation towards the communication device 121 and configure the first relay device 122 to serve as a relay between the communication device 121 and the network node 110.

Action 504

According to one option, the network node 110 may further transmit a negative acknowledgement, NACK, message to the at least one second relay device 123 indicating that the at least one second relay device 123 is not to serve as a relay between the communication device 121 and the network node 110. This means that the network node 110 may notify at least one second relay device 123 that it has not been determined by the network node 110 to perform the relay operation towards the communication device 121.

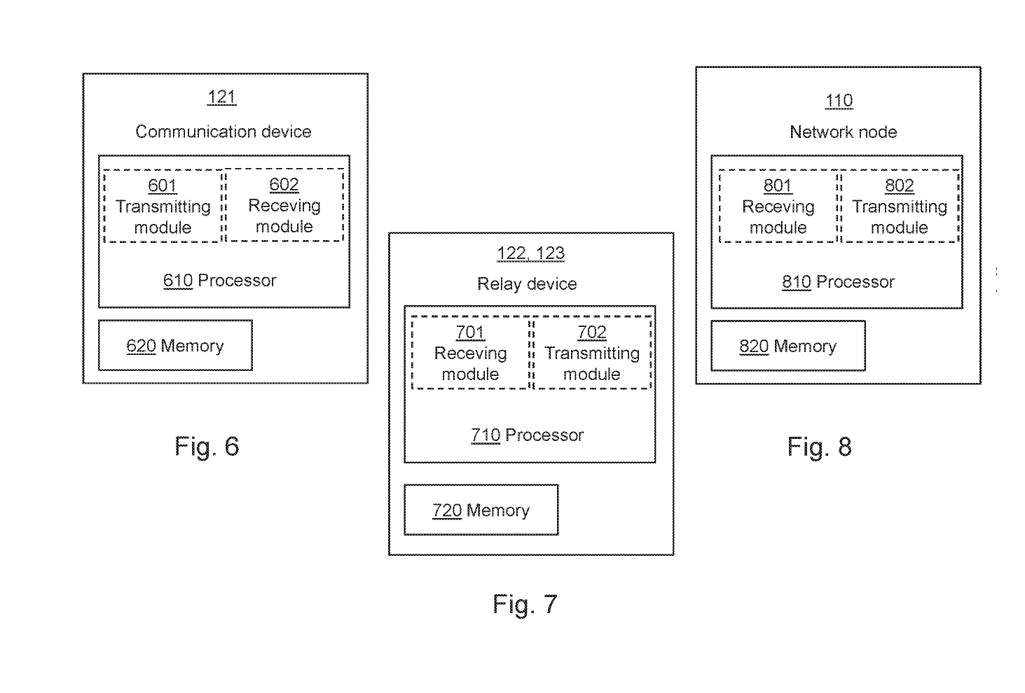

To perform the method actions in a communication device 121 for enabling a relay in a radio communications network 100, as described above in relation to FIG. 3, the communication device 121 may comprise the following arrangement depicted in FIG. 6.

The communication device 121 is configured to, e.g. by means of a transmitting module 601 configured to, transmit a request for a relay device 122, 123 to serve as a relay for the communication device 121. The transmitting module 601 may also be referred to a transmitter or transmitting unit, and may also be a processor 610, or processing module, of the communication device 121. The communication device 121 is further configured to, e.g. by means of a receiving module 602 configured to, receive an acknowledgement message, ACK, from a relay device 122 indicating that the relay device 122 is to serve as a relay to between the communication device 121 and a network node 110 in the radio communications network 100. The receiving module 602 may also be referred to a receiver or receiving unit, and may also be the processor 610, or processing module, of the communication device 121.

Also, in some embodiments, the communication device 121 is configured to, e.g. by means of the processor 610 being configured to, configure a relay connection with the relay device 122. Furthermore, the communication device 121 is configured to, e.g. by means of the processor 610 being configured to, determine that at least one property of the communication device 121 fulfils at least one condition.

In some embodiments, the at least one condition relates to one or more of: a signal strength or a channel quality towards a network node 110 in the radio communications network 100; a mobility information of the communication device 121; a power consumption requirement of the communication device 121; a subscription information of the communication device 121; a Quality-of-Service requirements of the communication device 121; an identity of the communication device 121; a group assignment of the communication device 121; an operator serving the communication device 121; and a battery operated indicator of the communication device 121.

To perform the method actions in a relay device 122, 123 for enabling a relay in a radio communications network 100, as described above in relation to FIG. 4, the relay device 122, 123 may comprise the following arrangement depicted in FIG. 7.

The relay device 122, 123 is configured to, e.g. by means of a receiving module 701 configured to, receive, from a communication device 121, a request to serve as a relay for the communication device 121. The receiving module 701 may also be referred to a receiver or receiving unit, and may also be the processor 710, or processing module, of the relay device 122, 123. The relay device 122, 123 is further configured to, e.g. by means of a transmitting module 702 configured to, transmit a control message to a network node 110 in the radio communications network 100 indicating that the relay device 122, 123 is able to serve as a relay between the communication device 121 and the network node 110. The transmitting module 702 may also be referred to a transmitter or transmitting unit, and may also be a processor 710; or processing module, of the relay device 122, 123.

Furthermore, the relay device 122, 123 is configured to, e.g. by means of the receiving module 701 being configured to, receive, from the network node 110, a first acknowledgement message, ACK, configuring the relay device 122 to serve as a relay between the communication device 121 and the network node 110. Alternatively; the relay device 122, 123 may be is configured to, e.g. by means of the receiving module 701 being configured to, determine whether or not it should be a relay device or not; e.g. enable/disable its relay function, according to some initial condition, such as, e.g. when having bad coverage and or low charged battery.

Also; the relay device 122, 123 is configured to, e.g. by means of the transmitting module 702 being configured to, transmit, to the communication device 121, a second acknowledgement message, ACK, indicating that the relay device 122; 123 is to serve as a relay between the communication device 121 and the network node 110.

In some embodiments, the relay device 122, 123 is configured to, e.g. by means of the transmitting module 702 being configured to, transmit the control message when at least one property of the communication device 121 fulfils at least one condition. Furthermore, in some embodiments, the at least one condition relates to one or more of: a signal strength or a channel quality between the communication device 121 and the relay device 122; a mobility information of the communication device 121; a power consumption requirements of the communication device 121; a subscription information of the communication device 121; a Quality-of-Service requirements of the communication device 121; the identity of the communication device 121; a group assignment of the communication device 121; an operator serving the communication device 121; and a battery operated indicator of the communication device 121.

In some embodiments, the relay device 122, 123 is also configured to, e.g. by means of the transmitting module 702 being configured to, transmit the control message when at least one condition is fulfilled by the relay device 122. Furthermore, in some embodiments, the at least one condition relates to one or more of: a signal strength or a channel quality between the relay device 122, 123 and the network node 110; a mobility information of the relay device 122, 123; a power consumption requirements of the relay device 122, 123; subscription information of the relay device 122, 123; a Quality-of-Service requirement of the relay device 122, 123; an identity of the relay device 122, 123; group assignment of the relay device 122, 123; an operator serving the relay device 122, 123; and a battery operated indicator of the relay device 122, 123.

To perform the method actions in a network node 110 for enabling a relay in a radio communications network 100, as described above in relation to FIG. 5, the network node 110 may comprise the following arrangement depicted in FIG. 8.

The network node 110 is configured to, e.g. by means of a receiving module 801 configured to, receive a control message from a first relay device 122 indicating that the first relay device 122 is able to serve as a relay between a communication device 121 and the network node 110. The receiving module 801 may also be referred to a receiver or receiving unit, and may also be the processor 810, or processing module, of the network node 110. The network node 110 is further configured to, e.g. by means of a transmitting module 802 configured to, transmit an acknowledgement message to the first relay device 122 configuring the first relay device 122 is to serve as a relay between the communication device 121 and the network node 110. The transmitting module 802 may also be referred to a transmitter or transmitting unit, and may also be a processor 810, or processing module, of the network node 110.

Furthermore, the network node 110 is configured to, e.g. by means of the transmitting module 801 being configured to, transmit a negative acknowledgement message to the at least one second relay device 123 indicating that the at least one second relay device 123 is not to serve as a relay between the communication device 121 and the network node 110.

Also, the network node 110 is configured to, e.g. by means of the processor 810 being configured to, determine that the first relay device 122 is to serve as a relay between the communication device 121 and the network node 110 based on at least one property of the first relay device 122 and/or at least one property of a link between the first relay device 122 and the network node 110. Furthermore, in some embodiments, the at least one property of the first relay device 122 and/or at least one property of a link between the first relay device 122 and the network node 110 relates to one or more of: a signal strength or a channel quality towards the communication device 121; a signal strength or a channel quality towards the first relay device 122; a mobility information of the first relay device 122; a mobility information of the communication device 121; a power consumption requirements of the first relay device 122; Quality-of-Service requirement of the first relay device 122; a Quality-of-Service, QoS, requirement of the communication device 121; an identity of the first relay device 122; an identity of the communication device 121; a group assignment of the first relay device 122; a group assignment of the communication device 121; an operator(s) serving the first relay device (122) and/or the communication device (121); and, a battery operated indicator of the communication device (121) and/or the first relay device (122).

The embodiments for enabling a relay in a radio communications network 100 may be implemented through one or more processors, such as, e.g. the processor 610 in the communication device 121 depicted in FIG. 6, the processor 710 in the relay device 122, 123 depicted in FIG. 7, and the processor 810 in the network node 110 depicted in FIG. 8, together with computer program code for performing the functions and actions of the embodiments therein. The program code mentioned above may also be provided as a computer program product, for instance in the form of a data carrier carrying computer program code or code means for performing the embodiments herein when being loaded into the processor 610 in the communication device 121, the processor 710 in the relay device 122, 123, and the processor 810 in the network node 110, respectively. The computer program code may e.g. be provided as pure program code in the communication device 121, the relay device 122, 123, and the network node 110, or on a server and downloaded to the communication device 121, the relay device 122, 123, and the network node 110. The carrier may be one of an electronic signal, optical signal, radio signal, or computer readable storage medium, such as, e.g. electronic memories like a RAM, a ROM, a Flash memory, a magnetic tape, a CD-ROM, a DVD, a Blueray disc, etc.

The communication device 121, the relay device 122, 123, and the network node 110 may further comprise a memory 620, 720, 820, respectively, which may be referred to or comprise one or more memory modules or units. The memory 620, 720, 820 may be arranged to be used to store executable instructions and data to perform the methods described herein when being executed in the communication device 121, the relay device 122, 123, and the network node 110, respectively. Those skilled in the art will also appreciate that the processors 610, 710, 810 and their respective memories 620, 720, 820 described above may refer to a combination of analog and digital circuits, and/or one or more processors configured with software and/or firmware, e.g. stored in the memory 620, 720, 820, that when executed by the one or more processors such as the processors 610, 710, 810 perform the methods as described above. One or more of the processors 610, 710, 810 and their respective memories 620, 720, 820, as well as the other digital hardware, may be included in a single application-specific integrated circuit (ASIC), or several processors and various digital hardware may be distributed among several separate components, whether individually packaged or assembled into a system-on-a-chip (SoC).

From the above it may be seen that the embodiments may further comprise a computer program product, comprising instructions which, when executed on at least one processor, e.g. the processors 610, 710, 810, cause the at least one processor to carry out the method for enabling a relay in a radio communications network 100. Also, some embodiments may, as described above, further comprise a carrier containing said computer program, wherein the carrier is one of an electronic signal, optical signal, radio signal, or computer readable storage medium.

The terminology used in the detailed description of the particular embodiments illustrated in the accompanying drawings is not intended to be limiting of the described method or the communication device, which instead should be construed in view of the enclosed claims.

As used herein, the term “and/or” comprises any and all combinations of one or more of the associated listed items.

Further, as used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation. The common abbreviation “etc.”, which derives from the Latin expression “et cetera” meaning “and other things” or “and so on” may have been used herein to indicate that further features, similar to the ones that have just been enumerated, exist.

As used herein, the singular forms “a”, “an” and “the” are intended to comprise also the plural forms as well, unless expressly stated otherwise. It will be further understood that the terms “includes,” “comprises,” “including” and/or “comprising,” when used in this specification, specify the presence of stated features, actions, integers, steps, operations, elements, and/or components, but do not preclude the presence or addition of one or more other features, actions, integers, steps, operations, elements, components, and/or groups thereof.

Unless otherwise defined, all terms comprising technical and scientific terms used herein have the same meaning as commonly understood by one of ordinary skill in the art to which the described embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The embodiments herein are not limited to the above described preferred embodiments. Various alternatives, modifications and equivalents may be used. Therefore, the above embodiments should not be construed as limiting.

1.-26. (canceled)

27. A method performed by a communication device for enabling a relay in a radio communications network, the method comprising:
transmitting a request for a relay device to serve as a relay for the communication device; and
receiving an acknowledgement message from a relay device indicating that the relay device is to serve as a relay between the communication device and a network node in the radio communications network.

28. The method according to claim 27, further comprising configuring a relay connection with the relay device.

29. The method according to claim 27, wherein transmitting further comprises determining that at least one property of the communication device fulfils at least one condition.

30. The method according to claim 29, wherein the at least one condition relates to one or more of: a signal strength or a channel quality towards a network node in the radio communications network; a mobility information of the communication device; a power consumption requirement of the communication device; subscription information of the communication device; a Quality-of-Service requirements of the communication device; an identity of the communication device; a group assignment of the communication device; an operator serving the communication device; a battery operated indicator of the communication device.

31. A communication device for enabling a relay in a radio communications network, the communication device comprising a transmitter configured to transmit a request for a relay device to serve as a relay for the communication device, and a receiver configured to receive an acknowledgement message from a relay device indicating that the relay device is to serve as a relay between the communication device and a network node in the radio communications network.

32. The communication device according to claim 31, further comprising a processor adapted to configure a relay connection with the relay device.

33. The communication device according to claim 31, further comprising a processor configured to determine that at least one property of the communication device fulfils at least one condition.

34. The communication device according to claim 33, wherein the at least one condition relates to one or more of: a signal strength or a channel quality towards a network node in the radio communications network; a mobility information of the communication device; a power consumption requirement of the communication device; subscription information of the communication device; a Quality-of-Service requirements of the communication device; an identity of the communication device; a group assignment of the communication device; an operator serving the communication device; a battery operated indicator of the communication device.

35. A method performed by a relay device for enabling a relay in a radio communications network, the method comprising:
receiving, from a communication device, a request to serve as a relay for the communication device;
transmitting, to a network node in the radio communications network, a control message indicating that the relay device is able to serve as a relay between the communication device and the network node;
receiving, from the network node, a first acknowledgement message configuring the relay device to serve as a relay between the communication device and the network node; and
transmitting, to the communication device, a second acknowledgement message indicating that the relay device is to serve as a relay between the communication device and the network node.

36. The method according to claim 35, wherein transmitting the control message is performed when at least one property of the communication device fulfils at least one condition.

37. The method according to claim 36, wherein the at least one condition relates to one or more of: a signal strength or a channel quality between the communication device and the relay device; a mobility information of the communication device; a power consumption requirements of the communication device; subscription information of the communication device; a Quality-of-Service requirements of the communication device; an identity of the communication device; a group assignment of the communication device; an operator serving the communication device.

38. The method according to claim 35, wherein transmitting the control message is performed when at least one condition is fulfilled by the relay device.

39. The method according to claim 38, wherein the at least one condition relates to one or more of: a signal strength or a channel quality between the relay device and the network node; a mobility information of the relay device; a power consumption requirements of the relay device; subscription information of the relay device; a Quality-of-Service requirement of the relay device; an identity of the relay device; a group assignment of the relay device; an operator serving the relay device; a battery operated indicator of the relay device.

40. A relay device for enabling a relay in a radio communications network, the relay device comprising a receiver configured to receive, from a communication device, a request to serve as a relay for the communication device, and a transmitter configured to transmit a control message to a network node in the radio communications network indicating that the relay device is able to serve as a relay between the communication device and the network node, wherein the receiver is further configured to receive, from the network node, a first acknowledgement message configuring the relay device to serve as a relay between the communication device and the network node, and wherein the transmitter is further configured to transmit, to the communication device, a second acknowledgement message indicating that the relay device is to serve as a relay between the communication device and the network node.

41. The relay device according to claim 40, wherein the transmitter is further configured to transmit the control message when at least one property of the communication device fulfils at least one condition.

42. The relay device according to claim 41, wherein the at least one condition relates to one or more of: a signal strength or a channel quality between the communication device and the relay device; a mobility information of the communication device; a power consumption requirements of the communication device; subscription information of the communication device; a Quality-of-Service requirements of the communication device; an identity of the communication device; a group assignment of the communication device; an operator serving the communication device.

43. The relay device according to claim 40, wherein the transmitter is further configured to transmit the control message when at least one condition is fulfilled by the relay device.

44. The relay device according to claim 41, wherein the at least one condition relates to one or more of: a signal strength or a channel quality between the relay device and the network node; a mobility information of the relay device; a power consumption requirements of the relay device; subscription information of the relay device; a Quality-of-Service requirement of the relay device; an identity of the relay device; a group assignment of the relay device; an operator serving the relay device; a battery operated indicator of the relay device.

45. A method performed by a network node for enabling a relay in a radio communications network, the method comprising:
receiving a control message from a first relay device indicating that the first relay device is able to serve as a relay between a communication device and the network node; and
transmitting an acknowledgement message to the first relay device configuring the first relay device to serve as a relay between the communication device and the network node.

46. The method according to claim 45, further comprising transmitting a negative acknowledgement message to at least one second relay device indicating that the at least one second relay device is not to serve as a relay between the communication device and the network node.

47. The method according to claim 45, further comprising determining that the first relay device is to serve as a relay between the communication device and the network node based on at least one property of the communication device and/or on at least one property of the first relay device.

48. The method according to claim 47, wherein the at least one property of the communication device and/or the at least one property of the first relay device relate to one or more of: a signal strength or a channel quality towards the communication device; a signal strength or a channel quality towards the first relay device; a mobility information of the first relay device; a mobility information of the communication device; a power consumption requirements of the first relay device; a Quality-of-Service requirement of the first relay device; a Quality-of-Service requirement of the communication device; an identity of the first relay device; an identity of the communication device; a group assignment of the first relay device; a group assignment of the communication device; an operator serving the first relay device; an operator serving the communication device; a battery operated indicator of the communication device; a battery operated indicator of the first relay device.

49. A network node for enabling a relay in a radio communications network, the network node comprising a receiver configured to receive a control message from a first relay device indicating that the first relay device is able to serve as a relay between a communication device and the network node, and a transmitter configured to transmit an acknowledgement message to the first relay device configuring the first relay device to serve as a relay between the communication device and the network node.

50. The network node according to claim 49, wherein the transmitter is further configured to transmit a negative acknowledgement message to at least one second relay device indicating that the at least one second relay device is not to serve as a relay between the communication device and the network node.

51. The network node according to claim 49, further comprising a processor configured to determine that the first relay device is to serve as a relay between the communication device and the network node based on at least one property of the communication device and/or on at least one property of the first relay device.

52. The network node according to claim 51, wherein the at least one property of the communication device and/or the at least one property of the first relay device relate to one or more of: a signal strength or a channel quality towards the communication device; a signal strength or a channel quality towards the first relay device; a mobility information of the first relay device; a mobility information of the communication device; a power consumption requirements of the first relay device; Quality-of-Service requirement of the first relay device; a Quality-of-Service requirement of the communication device; an identity of the first relay device; an identity of the communication device; a group assignment of the first relay device; a group assignment of the communication device; an operator serving the first relay device; an operator serving the communication device; a battery operated indicator of the communication device; a battery operated indicator of the first relay device.
